(19) United States
(12) Patent Application Publication
(10) Pub. No.: US 2026/0089025 A1
(43) Pub. Date: Mar. 26, 2026

(54) HETEROGENEOUS NETWORK CONTROL DEVICE

(71) Applicant: LITE-ON TECHNOLOGY CORPORATION, TAIPEI CITY (TW)

(72) Inventor: Yi Tung LIANG, Taipei City (TW)

(21) Appl. No.: 19/271,912

(22) Filed: Jul. 17, 2025

Related U.S. Application Data
(60) Provisional application No. 63/698,105, filed on Sep. 24, 2024.

(51) Int. Cl. H04L 12/28; H04L 61/103; H04L 101/622

(52) U.S. Cl. CPC H04L 12/2803; H04L 61/103; H04L 2101/622

(57) ABSTRACT

A heterogeneous network control device includes a processor configured to access a program and perform the following steps. First, use Media Access Control address of each of the heterogeneous network devices as index, and count packets transmitted from and received by each of the heterogeneous network devices respectively. Second, for any pair of the heterogeneous network devices, perform a candidate determination procedure. The candidate determination procedure includes the steps of obtaining packet statistics of the heterogeneous network devices such as deviation of packets and difference of packet counts; and marking the heterogeneous network device as candidate of hot spot or hot zone when its deviation of packets and difference of packet counts meets a predetermined condition.

### CROSS REFERENCE TO RELATED APPLICATIONS

This application claims the benefit of U.S. provisional application No. 63/698,105, filed September 24, 2024, the entirety of which is incorporated by reference herein.

### TECHNICAL FIELD

The present disclosure relates to marking hot zone and hot spot in smart home application, and, in particular, to a heterogeneous network control devices for smart home which performs statistical analysis of packets between any two of the heterogeneous network devices to determine hot zones and hot spots.

### BACKGROUND

The applications of household appliances for smart homes mostly rely on networking functions and terminal system control. Moreover, current automation control of smart household appliances is limited to the monitoring function thereof. These smart household appliances passively detect user’s activity area through their own sensors, and even can only perform scheduled control based on the user’s settings, but still cannot achieve full functional goal of active smart automation.

When a home member leaves the area where a terminal device is located, the terminal device remains normally turn-on because the home member does not intervene its operation. Or, when the home member leaves the room where the terminal device is located briefly but is still within the activity range of a small area, the terminal device may turn off the power of the household appliances because it cannot detect member activity or the home member, thus causing frequent turning on and turning off the household appliances. In the situations mentioned above, it cannot effectively save energy and may even cause damage to electronic appliances.

Accordingly, it is desirable to design a mechanism using a heterogeneous network control device to determine hot spots of member activity. This mechanism actively and efficiently manages the operation of smart appliances through heterogeneous network devices under the control of the controller.

### BRIEF SUMMARY

An embodiment of the present disclosure provides a heterogeneous network control device. The heterogeneous network control device includes a processor configured to access a program and perform the following steps. First, the processor obtains a topology associated with a plurality of heterogeneous network devices which include the heterogeneous network control device. Then, the processor uses MAC (Media Access Control) address of each of the heterogeneous network devices as index, and counts packets transmitted from and received by each of the heterogeneous network devices, respectively. Next, for any pair of the heterogeneous network devices, namely a first heterogeneous network device and a second heterogeneous network device, the processor performs a candidate determination procedure. The candidate determination procedure includes the following steps.

Within a fixed time period, the processor obtains the first standard deviation of the transmitted packet counts of the first heterogeneous network device and the second standard deviation of the received packet counts of the first heterogeneous network device, and it also obtains the third standard deviation of the transmitted packet counts of the second heterogeneous network device and the fourth standard deviation of the received packet counts of the second heterogeneous network device. Within the fixed time period, the processor obtains the first difference of the transmitted packet counts of the first heterogeneous network device and the second difference of the received packet counts of the first heterogeneous network device, and the third difference of the transmitted packet counts of the second heterogeneous network device and the fourth difference of the received packet counts of the second heterogeneous network device.

The process marks the first heterogeneous network device as a candidate when the first difference is greater than the first standard deviation or the second difference is greater than the second standard deviation. Also, the processor marks the second heterogeneous network device as a candidate when the third difference is greater than the third standard deviation or the fourth difference is greater than the fourth standard deviation.

In some aspects of the present embodiment, after all pairs of the heterogeneous network devices have been processed by the candidate determination procedure, the processor checks the candidate count of each heterogeneous network devices having been marked as candidate. Then, the processor determines any heterogeneous network device having candidate count greater than two as a smart device hot zone, a control device hot zone, or a home member hot spot according to the type information discovered by a heterogeneous network management protocol.

In some aspects of the present embodiment, through a device exploration and function management protocol, the processor classifies the heterogeneous network devices into control devices, smart home devices or home member devices, and attaches the type information in the packets of the heterogeneous network devices.

In some aspects of the present embodiment, the device exploration and function management protocol is Matter or IEEE-1905.1.5.

In some aspects of the present embodiment, the pairs which are marked as candidates are recorded in a candidate list.

Another embodiment of the present disclosure provides a non-transitory medium readable by a processor of a heterogeneous network control device. The processor reads the non-transitory medium and executes the following steps. First, the processor obtains a topology associated with a plurality of heterogeneous network devices which include the heterogeneous network control device. Then, the processor uses MAC (Media Access Control) address of each of the heterogeneous network devices as index, and counts packets transmitted from and received by each of the heterogeneous network devices, respectively. Next, for any pair of the heterogeneous network devices, namely a first heterogeneous network device and a second heterogeneous network device, the processor performs a candidate determination procedure. The candidate determination procedure includes the following steps.

Within a fixed time period, the processor obtains the first standard deviation of the transmitted packet counts of the first heterogeneous network device and the second standard deviation of the received packet counts of the first heterogeneous network device, and it also obtains the third standard deviation of the transmitted packet counts of the second heterogeneous network device and the fourth standard deviation of the received packet counts of the second heterogeneous network device. Within the fixed time period, the processor obtains the first difference of the transmitted packet counts of the first heterogeneous network device and the second difference of the received packet counts of the first heterogeneous network device, and the third difference of the transmitted packet counts of the second heterogeneous network device and the fourth difference of the received packet counts of the second heterogeneous network device.

The process marks the first heterogeneous network device as a candidate when the first difference is greater than the first standard deviation or the second difference is greater than the second standard deviation. Also, the processor marks the second heterogeneous network device as a candidate when the third difference is greater than the third standard deviation or the fourth difference is greater than the fourth standard deviation.

In some aspects of the another embodiment, after all pairs of the heterogeneous network devices have been processed by the candidate determination procedure, the processor checks the candidate count of each heterogeneous network devices having been marked as candidate; and the processor determines any heterogeneous network device having candidate count greater than two as a smart device hot zone, a control device hot zone, or a home member hot spot according to the type information discovered by the heterogeneous network management protocol.

### BRIEF DESCRIPTION OF THE DRAWINGS

The present disclosure can be more fully understood by reading the subsequent detailed description and examples with references made to the accompanying drawings, wherein:

FIG. 1 illustrates connectivity among three types of heterogeneous network devices;

FIG. 2 illustrates the control plane and the data plane under heterogeneous network architecture;

FIG. 3 schematically shows a heterogeneous network control device of the present disclosure for smart home application;

FIG. 4 shows the heterogeneous network device serving as the heterogeneous network control device, which includes a processor and a program;

FIG. 5 shows the main process performed by the processor;

FIG. 6 shows the process of the candidate determination procedure; and

FIG. 7 shows the process of a procedure for determining hot zone and hot spot.

### DETAILED DESCRIPTION

The following description is made for the purpose of illustrating the general principles of the disclosure and should not be taken in a limiting sense. The scope of the disclosure is best determined by reference to the appended claims.

Heterogeneous Network Device refers to devices within the same network system that are composed of different brands, protocols, functions, or platforms. These devices may support various communication technologies (such as Wi-Fi, Zigbee, Bluetooth, Thread, or Ethernet), and protocols (such as Matter, IEEE 1905.1, or Z-Wave), and may serve different roles and functions, such as sensors, controllers, or actuators.

In the present disclosure, heterogeneous network devices may include controller devices, home member devices and smart home devices.

The controller devices provide gateway with wired or wireless communication interface, for connecting various heterogeneous network devices in series, and communicates with local network and internet.

The home member devices usually are mobile devices used by home members personally, namely handheld devices including but not limited to smartphones, tablets, and smart watches.

The smart home devices are fixed and internet-connectable smart household devices used to provide various types of home life services or health care supervision. They must support device exploration and function management protocol(s) for operation of heterogeneous controller system.

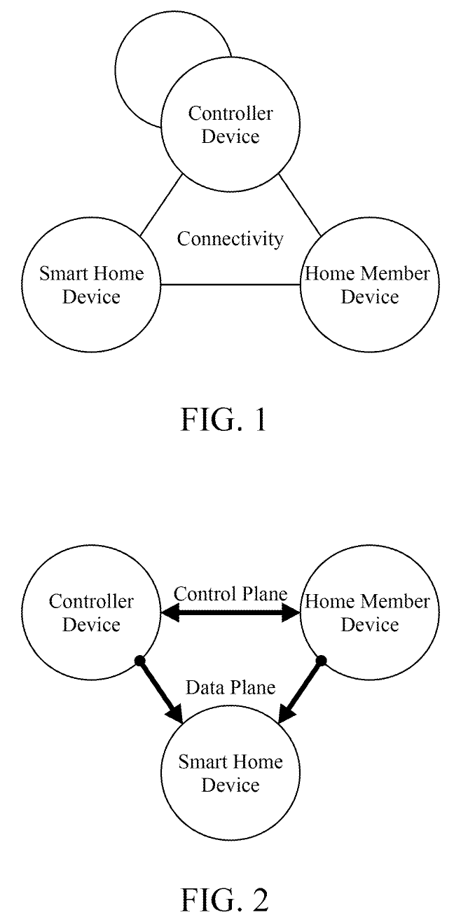

FIG. 1 illustrates connectivity among three types of the aforementioned heterogeneous network devices. The three aforementioned heterogeneous network devices can be interconnected, but only the controller device can connect to another controller device. Neither connection can be established between two home member devices, or between two smart home devices.

The controller devices and home member devices can perform control tasks in the smart home, while the smart home device can only perform data transmission, and also provides life services or health care. The classification of the three types of heterogeneous network devices is determined by “device exploration and function management protocol(s)”, for example, Matter and IEEE-1905.1, based on user's settings or the general default device type of the protocol, such as Device Type Data Model of Matter protocol. The determination result is recorded in the protocol packet content, collected and classified by the heterogeneous controller system.

FIG. 2 illustrates the control plane and the data plane under heterogeneous network architecture.

The control plane is responsible for decision-making, device control, network management, and command issuance, serving as the "brain" of the entire smart network. Typical device types include the heterogeneous network control device, namely the controller device (e.g., smart home hubs, home gateways, edge computing nodes), and user interface devices (e.g., tablets, smartphone (apps), which can act as home member devices).

The data plane is responsible for handling actual data transmission, packet processing, sensor data collection, and command execution. It does not participate in decision-making or control. Typical device types include smart home devices, sensors (e.g., temperature and humidity sensors, motion detectors), actuators (e.g., light switches, door lock control modules), data-uploading devices such as cameras and smart plugs. Such devices operate only based on commands from the control plane. Their primary functions are data collection and action execution.

According to the present disclosure, a heterogeneous network control device determines hot spots and hot zones by collecting packet statistics from the control plane and data plane of a heterogeneous network system, and thus, there is no need to use the assistance of other detection instruments or appliances. A detailed description is provided as follows.

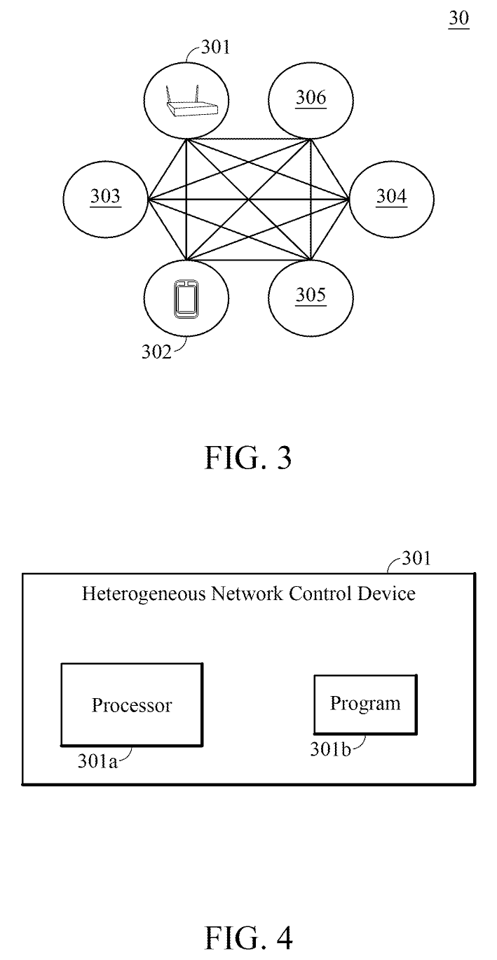

FIG. 3 schematically shows a heterogeneous network control device of the present disclosure for smart home application (alternatively referred to as heterogeneous network system) 30.

The heterogeneous network system 30 includes a plurality of heterogeneous network devices, and for example but not limited to, there are six heterogeneous network devices 301~306 in FIG. 3. In this embodiment, the heterogeneous network device 301 can serve as a heterogeneous network control device (or a controller device), the heterogeneous network device 302 may be a home member device (namely, a handheld device such as a smartphone of a user or family member), and the other heterogeneous network devices 303~306 may be smart home devices.

It should be noted that each of the heterogeneous network devices 301~306 use its MAC (Media Access Control) address as index for identification, according to the present disclosure.

FIG. 4 shows the heterogeneous network device 301 serving as the heterogeneous network control device, which includes a processor 301a and a program 301b. Hereinafter, the heterogeneous network device 301 is also referred to as the heterogeneous network control device. The program 301b may be pre-installed in the heterogeneous network device 301 or be read out from a non-transitory medium (not shown in FIG. 4).

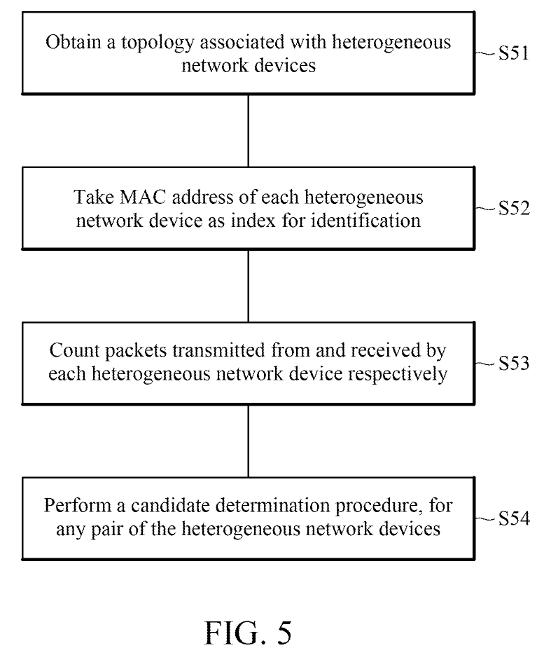

The processor 301a of the heterogeneous network control device 301 is configured to access the program 301b and perform the following steps. FIG. 5 shows the main process performed by the processor 301a.

In addition, the processor 301a is configured to extract the type information from the packets to classify each of the plurality of heterogeneous network devices as belonging to a control plane or a data plane. The processor initiates a control operation via the control plane for execution by a heterogeneous network device on the data plane determined to be the smart device hot zone, the control device hot zone, or the home member hot spot.

Furthermore, the processor is configured to initiate the control operation for a heterogeneous network device determined to be the smart device hot zone, the control device hot zone, or the home member hot spot. The control operation includes adjusting a temperature setting, switching the heterogeneous network device to an energy-saving mode, or activating a predefined smart home service.

In step S51, the processor 301a obtains a topology associated with a plurality of heterogeneous network devices. For example, the processor 301a obtains the topology associated with the heterogeneous network devices 301~306, as shown in FIG. 4.

In step S52, the processor 301a takes MAC (Media Access Control) address of each of the heterogeneous network devices (301~306) as index for identification.

In step S53, the processor 301a counts packets transmitted from and received by each of the heterogeneous network devices 301~306 respectively.

In step S54, the processor 301a performs a candidate determination procedure, for any pair of the heterogeneous network devices 301~306, namely a first heterogeneous network device A, and a second heterogeneous network device B.

The transmitted packet counts of the first heterogeneous network device (Src_A_pc), the transmitted packet counts of the second heterogeneous network device (Src_B_pc), the received packet counts of the first heterogeneous network device (Dst_A_pc), and the received packet counts of the second heterogeneous network device (Dst_B_pc) will be recorded. These recorded packet counts are used in the candidate determination procedure. The process of the candidate determination procedure will be described in detail as follows.

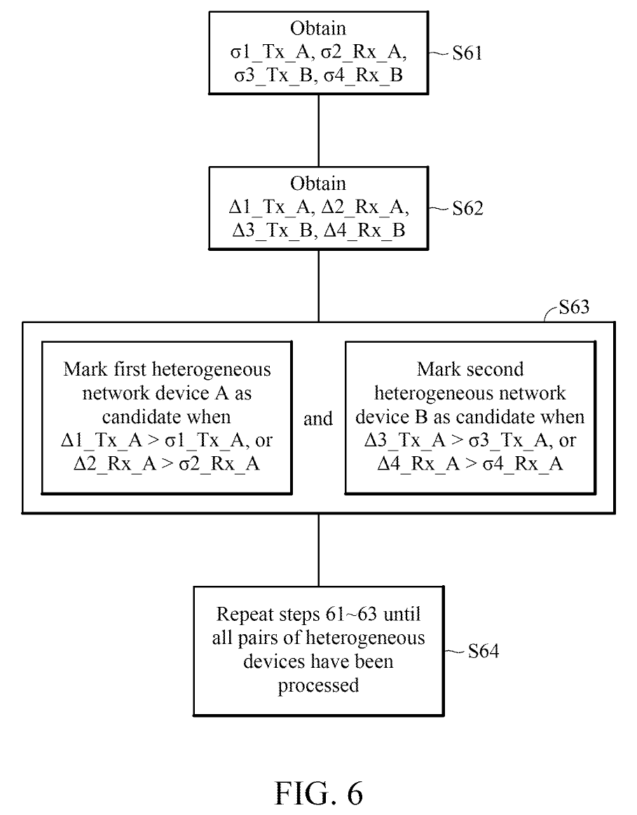

FIG. 6 shows the process of the candidate determination procedure. The candidate determination procedure is performed by the processor 301a, and includes the following steps.

In step S61, within a fixed time period, the processor 301a obtains a first standard deviation σ1_Tx_A from the transmitted packet counts of the first heterogeneous network device (Src_A_pc), and obtains a second standard deviation σ2_Rx_A from the received packet counts of the first heterogeneous network device (Dst_A_pc). Also, within the fixed time period, the processor 301a obtains a third standard deviation σ3_Tx_b from the transmitted packet counts of the second heterogeneous network device (Src_B_pc), and obtains a fourth standard deviation σ4_Rx_B from the received packet counts of the second heterogeneous network device (Dst_B_pc).

In step S62, within the fixed time period, the processor 301a obtains a first difference Δ1_Tx_A from the transmitted packet counts of the first heterogeneous network device (Src_A_pc), and obtains a second standard deviation Δ2_Rx_A from the received packet counts of the first heterogeneous network device (Dst_A_pc). Also, within the fixed time period, the processor 301a obtains a third standard deviation Δ3_Tx_B from the transmitted packet counts of the second heterogeneous network device (Src_B_pc), and obtains a fourth standard deviation Δ4_Rx_B from the received packet counts of the second heterogeneous network device (Dst_B_pc). Here, the term “difference” (Δ) is used to reflect the trend of increase or decrease in the packet counts. Note that steps S61 and step S62 are not necessarily executed in sequence and may be performed concurrently.

In step 63, the processor 301a marks the first heterogeneous network device A as a candidate when the first difference Δ1_Tx_A is greater than the first standard deviation σ1_Tx_A (i.e., Δ1_Tx_A > σ1_Tx_A) or the second difference Δ2_Rx_A is greater than the second standard deviation σ2_Rx_A (i.e., Δ2_Rx_A > σ2_Rx_A).

Moreover, in step 63, the processor 301a marks the second heterogeneous network device B as the candidate when the third difference Δ3_Tx_B is greater than the third standard deviation σ3_Tx_B (i.e., Δ3_Tx_B > σ3_Tx_B) or the fourth difference Δ4_Rx_B is greater than the fourth standard deviation σ4_Rx_B (i.e., Δ4_Rx_B > σ4_Rx_B).

When the first heterogeneous network device A is marked as the candidate of hot zone or hot spot, its candidate counts are increased by one. Also, When the second heterogeneous network device B is marked as the candidate of hot zone or hot spot, its candidate counts are increased by one.

In step 64, the processor 301a repeats the steps 61 ~ 63 until all pairs of the heterogeneous network devices have been processed by the candidate determination procedure. It is noted that the pairs which are marked as candidates may be recorded in a candidate list.

After all pairs of the heterogeneous network devices have been processed by the candidate determination procedure, the processor 301a performs a procedure for determining hot zone and hot spot.

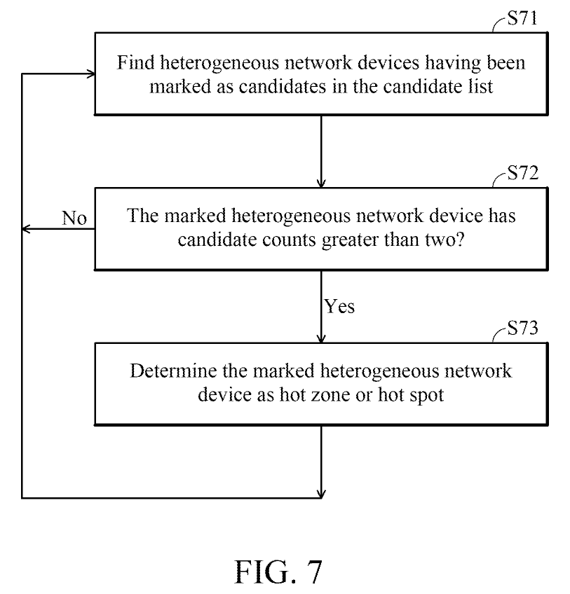

FIG. 7 shows the process of a procedure for determining hot zone and hot spot. Such procedure is performed by the processor 301a, and includes the following steps.

In step S71, the processor 301a finds one of the heterogeneous network devices having been marked as candidates in the candidate list.

In step S72, the processor 301a determines whether the marked heterogeneous network device has candidate count greater than two. If the candidate count is greater than two (step S72: Yes), then in step S73, the processor 301a determines the marked heterogeneous network device as a smart device hot zone, a control device hot zone, or a home member hot spot according to the type information discovered by a heterogeneous network management protocol, and then the processor 301a proceeds to the step S71 to check another marked candidate. Otherwise, If the candidate count is not greater than two (step S72: No), the processor 301a proceeds to the step S71 to find the next heterogeneous network devices having been marked as candidate, and repeats the steps 72 ~73.

Note that the processor 301a classifies in advance the heterogeneous network devices into control devices, smart home devices or home member devices, and attaches the type information in the packets of the heterogeneous network devices. In the present embodiment, the device exploration and function management protocol is Matter or IEEE-1905.1, but is not limited thereto.

In FIG. 3, the heterogeneous network device 301 is a heterogeneous network control device (i.e., a controller device), the heterogeneous network device 302 is a smartphone of a user or family member), and the other heterogeneous network devices 303~306 may be smart home devices. For example, the heterogeneous network device 303 is an air conditioner on the second floor of the house, and the heterogeneous network device 306 is a central heating system on the first floor of the house. When the user (the heterogeneous network device 302) leaves the space where the air conditioner (the heterogeneous network device 303) is located, the traffic changes between the user (302) and the heterogeneous network control device (301). The user goes to the first floor and turns on the central heating system (306). The heterogeneous network control device (301) can obtain the packet statistics of the heterogeneous network devices and determine new hot spot or hot zone.

The heterogeneous network control device 301 can determine hot spot and/or hot zone based on packet statistics processed by the procedures in FIGS. 5 to 7. After determining hot spot and/or hot zone, the heterogeneous network control device 301 may intervene in the control of the heterogeneous network devices for smart home application based on judging changes in hot spots of user’s activity (how to perform smart operations is not within the scope of this disclosure.

In summary, the present disclosure first obtains the classification of smart home heterogeneous network devices for smart home (namely, the controller device, home member device, and smart home device) and network topology by combining the system operating according to IEEE-1905.1 or Matter protocol, and performs statistical analysis of packets between any two of the heterogeneous network devices to determine hot zones and hot spots. By accurately determining the hot zone and hot spot according to the present disclosure, automated smart device services (power control, temperature setting, mechanical operations, etc.) can be carried out based on user’s settings or assistance of AI system.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A heterogeneous network control device, comprising:
a processor configured to access a program and perform the steps of:
obtaining a topology associated with a plurality of heterogeneous network devices which include the heterogeneous network control device;
using MAC (Media Access Control) address of each of the heterogeneous network devices as index, and counting packets transmitted from and received by each of the heterogeneous network devices respectively;
for any pair of the heterogeneous network devices, namely a first heterogeneous network device and a second heterogeneous network device, performing a candidate determination procedure;
wherein the candidate determination procedure includes the steps of:
within a fixed time period, obtaining the first standard deviation of the transmitted packet counts of the first heterogeneous network device and the second standard deviation of the received packet counts of the first heterogeneous network device, and obtaining the third standard deviation of the transmitted packet counts of the second heterogeneous network device and the fourth standard deviation of the received packet counts of the second heterogeneous network device;
within the fixed time period, obtaining the first difference of the transmitted packet counts of the first heterogeneous network device and the second difference of the received packet counts of the first heterogeneous network device, and the third difference of the transmitted packet counts of the second heterogeneous network device and the fourth difference of the received packet counts of the second heterogeneous network device;
marking the first heterogeneous network device as a candidate when the first difference is greater than the first standard deviation or the second difference is greater than the second standard deviation;
marking the second heterogeneous network device as a candidate when the third difference is greater than the third standard deviation or the fourth difference is greater than the fourth standard deviation.

2. The heterogeneous network control device of claim 1, wherein after all pairs of the heterogeneous network devices have been processed by the candidate determination procedure, the processor checks the candidate count of each heterogeneous network devices having been marked as candidate; and
the processor determines any heterogeneous network device having candidate count greater than two as a smart device hot zone, a control device hot zone, or a home member hot spot according to a type information discovered by a heterogeneous network management protocol.

3. The heterogeneous network control device of claim 2, wherein through a device exploration and function management protocol, the processor classifies the heterogeneous network devices into control devices, smart home devices or home member devices, and attaches the type information in the packets of the heterogeneous network devices.

4. The heterogeneous network control device of claim 3, wherein the device exploration and function management protocol is Matter or IEEE-1905.1.

5. The heterogeneous network control device of claim 2, wherein the pairs which are marked as candidates are recorded in a candidate list.

6. The heterogeneous network control device of claim 3, wherein the processor is further configured to extract the type information from the packets to classify each of the plurality of heterogeneous network devices as belonging to a control plane or a data plane, and wherein the processor initiates a control operation via the control plane for execution by a heterogeneous network device on the data plane determined to be the smart device hot zone, the control device hot zone, or the home member hot spot.

7. The heterogeneous network control device of claim 6, wherein the processor is further configured to initiate the control operation for a heterogeneous network device determined to be the smart device hot zone, the control device hot zone, or the home member hot spot, the control operation comprising adjusting a temperature setting, switching the heterogeneous network device to an energy-saving mode, or activating a predefined smart home service.

8. A non-transitory medium readable by a processor of a heterogeneous network control device to execute the steps of:
obtaining a topology associated with a plurality of heterogeneous network devices;
using MAC (Media Access Control) address of each of the heterogeneous network devices as index, and counting packets transmitted from and received by each of the heterogeneous network devices respectively;
for any pair of the heterogeneous network devices including a first heterogeneous network device and a second heterogeneous network device, performing a candidate determination procedure;
wherein the candidate determination procedure includes the steps of:
within a fixed time period, obtaining the first standard deviation of the transmitted packet counts of the first heterogeneous network device and the second standard deviation of the received packet counts of the first heterogeneous network device, and obtaining the third standard deviation of the transmitted packet counts of the second heterogeneous network device and the fourth standard deviation of the received packet counts of the second heterogeneous network device;
within the fixed time period, obtaining the first difference of the transmitted packet counts of the first heterogeneous network device and the second difference of the received packet counts of the first heterogeneous network device, and the third difference of the transmitted packet counts of the second heterogeneous network device and the fourth difference of the received packet counts of the second heterogeneous network device;
marking the first heterogeneous network device as a candidate when the first difference is greater than the first standard deviation or the second difference is greater than the second standard deviation;
marking the second heterogeneous network device as a candidate when the third difference is greater than the third standard deviation or the fourth difference is greater than the fourth standard deviation.

9. The non-transitory medium of claim 8, wherein after all pairs of the heterogeneous network devices have been processed by the candidate determination procedure, the processor checks the candidate count of each heterogeneous network devices having been marked as candidate; and
the processor determines any heterogeneous network device having candidate count greater than two as a smart device hot zone, a control device hot zone, or a home member hot spot according to the type information discovered by the heterogeneous network management protocol(s).

10. The non-transitory medium of claim 9, wherein through a device exploration and function management protocol, the processor classifies the heterogeneous network devices into control devices, smart home devices or home member devices, and attaches the type information in the packets of the heterogeneous network devices.

11. The non-transitory medium of claim 10, wherein the device exploration and function management protocol is Matter or IEEE-1905.1.

12. The non-transitory medium of claim 8, wherein the pairs which are marked as candidates are recorded in a candidate list.

13. The non-transitory medium of claim 10, wherein the processor further execute the steps of extracting the type information from the packets to classify each of the plurality of heterogeneous network devices as belonging to a control plane or a data plane, and wherein the processor initiates a control operation via the control plane for execution by a heterogeneous network device on the data plane determined to be the smart device hot zone, the control device hot zone, or the home member hot spot.

14. The non-transitory medium of claim 13, wherein the processor further execute the steps of initiating the control operation for a heterogeneous network device determined to be the smart device hot zone, the control device hot zone, or the home member hot spot, the control operation comprising adjusting a temperature setting, switching the heterogeneous network device to an energy-saving mode, or activating a predefined smart home service
